(19) United States
(12) Patent Application Publication
(10) Pub. No.: US 2004/0200246 A1
(43) Pub. Date: Oct. 14, 2004

(54) Changeable combination skidsteer lock

(76) Inventor: Bryan Witchey, Cross Junction, VA (US)

Correspondence Address: Richard C. Litman, LITMAN LAW OFFICES, LTD., P.O. Box 15035, Arlington, VA, 22215, US

(21) Appl. No.: 10/822,801

(22) Filed: Apr. 13, 2004

Related U.S. Application Data
(60) Provisional application No. 60/462,814, filed on Apr. 14, 2003.

(51) Int. Cl. G05G 5/00; F16H 57/00; B60R 21/00

(52) U.S. Cl. 70/14; 70/203

(57) ABSTRACT

The changeable combination skidsteer lock is an anti-theft device for a skid steer loader. The device attaches to the safety cage of the skid loader, proximate to one of the skid loader's drive controls. A U-bar component of the skid steer lock fits around one of the skid loader's drive controls to prevent operation of the drive control, preventing theft of the skid loader. A base plate is located on the inside of the cage, and is bolted to a mounting plate on the outside of the cage. Legs of the U-bar engage with a pair of sleeves extending from the base plate. In one embodiment, a locking mechanism is contained within a housing on the base plate to lock the U-bar securely in place. In an alternate embodiment, the U-bar is adapted to receive the shackle of a separate padlock, whereby the padlock secures the U-bar in place.

### CROSS-REFERENCE TO RELATED APPLICATION

This application claims the benefit of U.S. Provisional Patent Application Serial No. 60/462,814, filed Apr. 14, 2003.

### BACKGROUND OF THE INVENTION

1. Field of the Invention

The present invention relates generally to anti-theft devices for vehicles. More specifically, the invention is an anti-theft device for a skid steer loader to prevent operation of steering controls of the skid steer loader, thereby preventing unauthorized control and use of the skid steer loader.

2. Description of the Related Art

Skid steer loaders are widely used in construction, agriculture, industrial, and numerous other settings. Most typically used in an outdoor setting, a skid steer loader is frequently left at a job site until a project is completed, or until the skid steer loader is no longer required. Often, a skid steer loader is left unattended at the end of a workday and overnight, where it may become the target of thieves and vandals. While the risk of theft and vandalism may be reduced by fencing-in a job site and/or providing a night watchman, such measures are expensive and not entirely effective. A convenient, economical, and easy to use locking mechanism which renders the skid steer loader inoperative for practical purposes, and which can be put in place at the end of the work day and removed at the beginning of the next day without the expenditure of significant time and effort is therefore desirable.

Several devices are known for locking an automobile steering wheel or ignition lock. U.S. Pat. No. 4,008,590, issued Feb. 22, 1977 to Berkowitz et al., discloses a locking case which conforms to a steering column and covers the vehicle ignition. U.S. Pat. No. 5,920,254, issued Jul. 6, 1999 to C. Hsieh, describes a steering wheel lock with an alarm and a radio transmitter.

Still other lock devices are known for locking a floor shift gear lever, including U.S. Pat. No. 1,280,690, issued on Oct. 8, 1918 to E. Eckert (flat bar having a first end mounted to a seat or other structure of an automobile, and a second end having a plurality of holes to receive a padlock; padlock is fitted around shift lever and locked through at least one of the holes); U.S. Patent No. 1,453,004, issued Apr. 24, 1923 to N. Collion (floor-mounted bar engages with a fitting clamped around shift lever); U.S. Pat. No. 4,693,099, issued Sep. 15, 1987 to J. Cykman (rigid bar secured to a body portion of the motorcar and a padlock body fixedly mounted onto the bar, a separate padlock shackle adapted to be locked to the padlock body); U.S. Pat. No. 5,331,307, issued Jul. 19, 1994 to N. Eizen (mounting bracket bolted to floor near gear lever and a yoke received by holes in the bracket); U.S. Pat. No. 5,570,600, issued Nov. 5, 1996 to W. P. Hua (similar to the Eizen device, but with a U-shaped sleeve having lugs receiving the yoke or U-shaped bar); and U.S. Pat. No. 5,572,889, issued Nov. 12, 1996 to W. Ping-Hua (similar to the '600 device, but with a cylindrical sleeve inserted over the gear shift lever).

U.S. Pat. No. 1,384,590, issued Jul. 12, 1921 to V. R. Buttone, describes a lock for locking the control levers of an automobile having a U-bar with aligned recesses, a crossbar having lugs which receive the parallel legs of the U-bar, and a locking rod disposed in the crossbar which engages recesses in the U-shaped bar and in the crossbar. U.S. Pat. No. 5,195,340, issued Mar. 23, 1993 to T. Huang, shows a lock with a U-shaped bar having legs that extend transversely through a hollow rod having a key plug assembly and a locking plate assembly disposed in the hollow rod. U.S. Pat. No. 5,823,021, issued Oct. 20, 1998 to C. Chang, discloses a padlock having a U-shaped shackle and a locking mechanism arranged in a cylindrical body.

A locking bar for a skid steer loader is described in my prior patent, U.S. Pat. No. 6,173,590, issued Jan. 16, 2001. Additional locking devices for a skid steer loader are described in my prior patents, U.S. Pat. No. 6,539,757, issued Apr. 1, 2003 and U.S. Pat. No. 6,553,797, issued on Apr. 29, 2003.

Additional control-lever locking devices are disclosed by U.S. Pat. No. 1,165,352, issued Dec. 21, 1915 to W. Whiteside, and U.S. Pat. No. 1,371,886, issued Mar. 15, 1921 to J. Gage.

None of the above inventions and patents, taken either singly or in combination, is seen to describe the instant invention as claimed. Thus a changeable combination skidsteer lock solving the aforementioned problems is desired.

### SUMMARY OF THE INVENTION

The changeable combination skid steer lock is an anti-theft device for a skid steer utility loader (skid loader). The device attaches to the safety cage of the skid loader, proximate to one of the skid loader's drive controls. A U-bar component of the skid steer lock fits around one of the skid loader's drive controls to secure the drive control in place, preventing operation of the drive control. With the drive control secured, operation of the skid loader is prevented, thereby preventing theft of the skid loader.

A base plate and a mounting plate secure the skid steer lock to the safety cage of the skid loader. The base plate is located on the inside of the cage, and is bolted to the mounting plate located on the outside of the cage. A pair of sleeves extend from the base plate. The legs of a U-bar are received by the sleeves, with the U-bar positioned around the skid loader's drive control. In one embodiment, a locking mechanism is contained within a housing on the base plate to lock the U-bar securely in place. A preferred locking mechanism includes a changeable combination lock. In an alternate embodiment, the U-bar is adapted to receive the shackle of a separate padlock either behind the mounting plate or through one of the sleeves, whereby the padlock secures the U-bar in place.

These and other features of the present invention will become readily apparent upon further review of the following specification and drawings.

### BRIEF DESCRIPTION OF THE DRAWINGS

FIG. 1 is an environmental, perspective view of a skid steer lock according to the present invention.

FIG. 2 is a top view of the base plate of a skid steer lock according to the present invention.

FIG. 3A is a diagrammatic side view showing a locking mechanism in an unlocked position that is contained within a housing on the base plate, the housing and base plate being shown in phantom.

FIG. 3B is a diagrammatic side view showing a locking mechanism in a locked position that is contained within a housing on the base plate, the housing and base plate being shown in phantom.

FIG. 4 is a plan view of the mounting plate of a skid steer lock according to the present invention.

FIG. 5 is a plan view of the U-bar of a skid steer lock according to the present invention.

FIG. 6 is a top view of a skid steer lock according to the present invention, showing the U-bar stored in a storage sleeve.

FIG. 7 is a perspective view of an alternative embodiment of a skid steer lock according to the present invention.

FIG. 8 is a perspective view of a second alternative embodiment of a skid steer lock according to the present invention.

FIG. 9 is a plan view of the U-bar of the skid steer lock shown in FIG. 7.

Similar reference characters denote corresponding features consistently throughout the attached drawings.

### DETAILED DESCRIPTION OF THE PREFERRED EMBODIMENTS

The present invention is a skid steer lock for locking a drive control of a skid steer loader (skid loader) vehicle. The skid steer lock, designated generally as 10 in the drawings, effectively disables the operation of a skid loader by locking a drive control lever L in place.

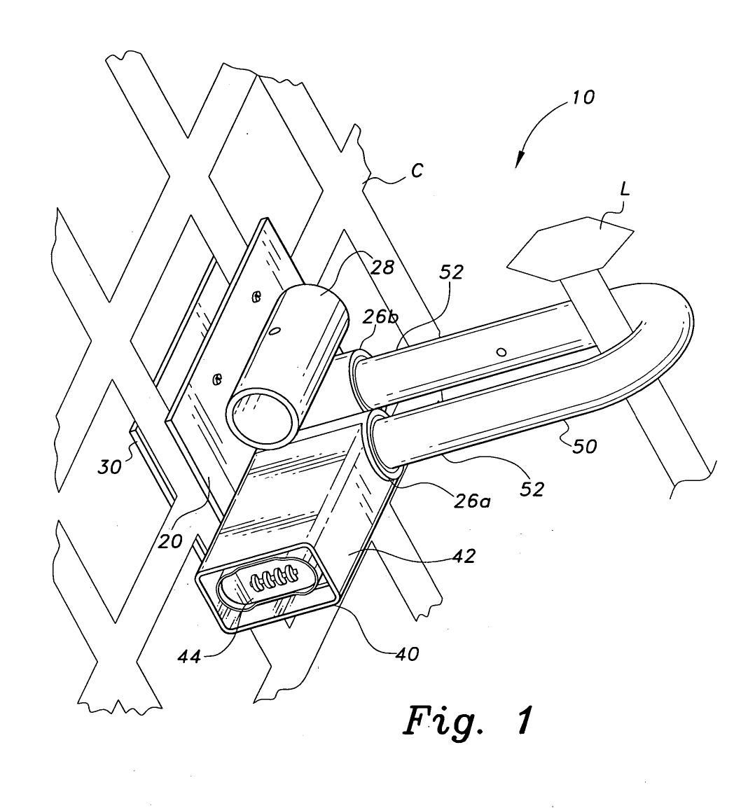

Referring now to FIG. 1, the skid steer lock 10 comprises a base plate 20 and a mounting plate 30. The skid steer lock 10 is mounted to the safety cage C of a skid loader by placing the base plate 20 against an interior surface of the safety cage C, locating the mounting plate 30 against an exterior surface of the safety cage C in alignment with the base plate 20, and bolting the base plate 20 and the mounting plate 30 together, thereby clamping the skid steer lock 10 to the safety cage C. Alternatively, U-bolts or other hardware may be substituted for the mounting plate 30. Additionally, the base plate 20 can be welded to the safety cage 30, eliminating the mounting plate 30 entirely. For security, the skid steer lock 10 is preferably mounted by fastening the base plate 20 and the mounting plate 30 together with non-reversing bolts, using a small amount of friction-activated adhesive coated on the bolt threads.

A pair of sleeves 26a, 26b are mounted on a front surface of the base plate 20, the sleeves 26a, 26b extending normal to the base plate 20. A U-bar 50 has a pair of parallel legs 52 that are removably received by the sleeves 26a, 26b. In use, the U-bar 50 is positioned around a drive control lever L of a skid loader, and engaged with the sleeves 26a, 26b. A locking assembly 40 secures the U-bar 50 in place in a locked configuration, or releases the U-bar 50 in an unlocked configuration.

The locking assembly 40 is disposed on one of the sleeves 26a, extending laterally from the sleeve 26a. The locking assembly 40 includes a housing 42 that is attached both to sleeve 26a and the base plate 20. A lock mechanism 44 is slidably disposed within the housing 42, movable between a locked and an unlocked position. The lock mechanism 44 is preferably a combination lock mechanism having a changeable combination. It can be recognized, however, that a variety of types of lock mechanisms are suitable.

A storage sleeve 28 is mounted transversely on the base plate 20, and serves to hold the U-bar 50 when the skid steer lock 10 is not in use.

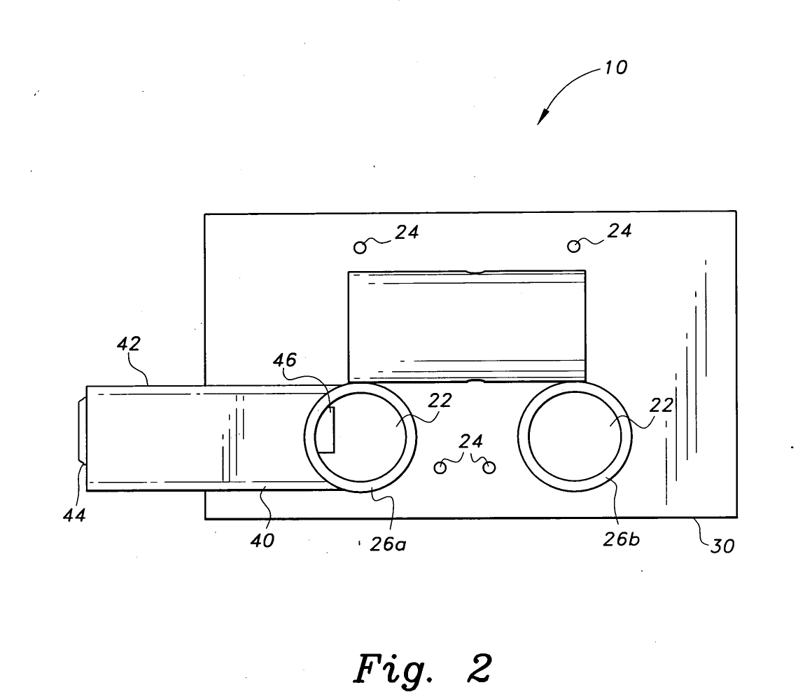

Turning now to FIG. 2, the skid steer lock 10 is seen from the top, with the U-bar 50 removed. It can now be seen that apertures 22 are defined in the base plate 20 in alignment with the sleeves 26a, 26b. The apertures 22 allow legs 52 of the U-bar 50 to extend through the base plate 20. Additional apertures 24 in the base plate 20 accommodate fasteners, such as bolts, for mounting the skid steer lock 10.

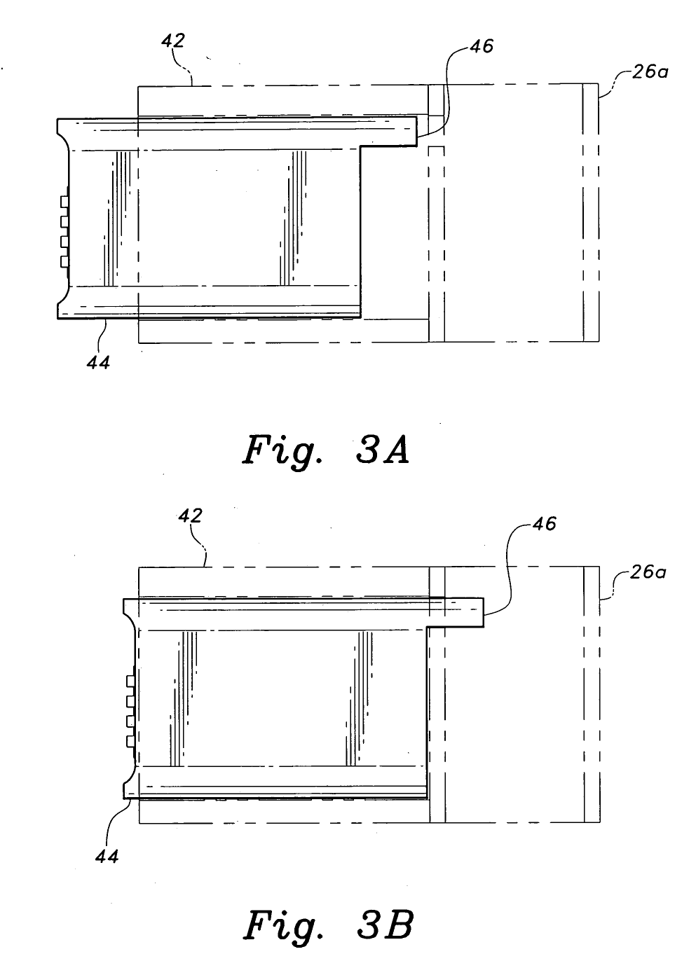

In FIG. 2, a latch member 46 of the locking assembly can be seen extending into sleeve 26a. Turning to FIGS. 3A and 3B, the latch member 46 is shown extending from the lock mechanism 44. In a locked position, shown in FIG. 3B, the lock mechanism 44 is pushed into the housing 42 so that the latch member 46 extends through an opening in the side of sleeve 26a into the interior of sleeve 26a. In an unlocked position, shown in FIG. 3A, the lock mechanism 44 is partially retracted from the housing 42, whereby the latch member 46 is withdrawn from the interior of the sleeve 26a. The lock mechanism 44 is spring-biased within the housing 42 toward the unlocked position. In a locked state, the lock mechanism 44 remains in the locked position, with the latch member extended into the sleeve 26a, once pushed into the locked position against the spring bias. In an unlocked state, the spring bias returns the lock mechanism 44 to its unlocked position, withdrawing the latch member 46 from the sleeve 26a.

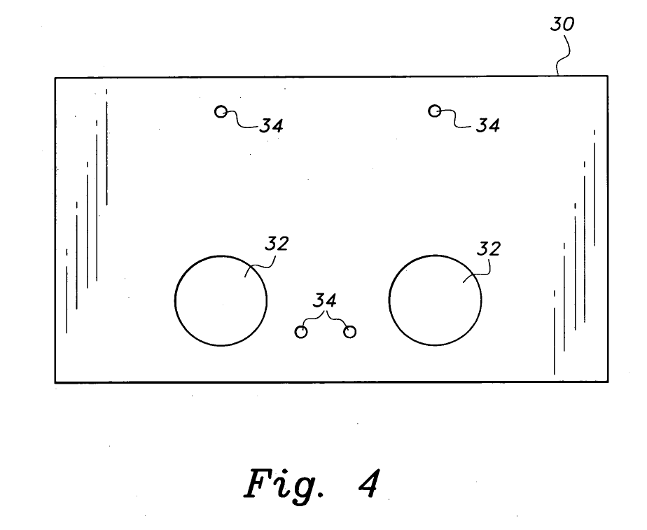

Turning now to FIG. 4, the mounting plate 30 is illustrated. Apertures 32 are defined in the mounting plate 30 to be in alignment with the apertures 22 of the base plate 20 when the skid steer lock 10 is installed. The apertures 32 allow legs 52 of the U-bar 50 to extend through the mounting plate 30. Additional apertures 34 in the mounting plate 30 accommodate fasteners, such as bolts, for mounting the skid steer lock 10.

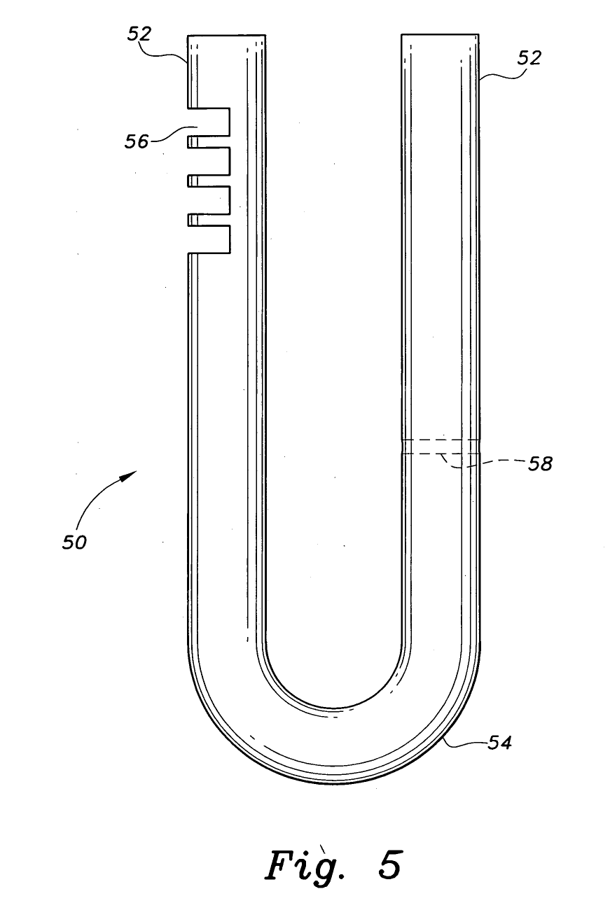

Turning now to FIG. 5, the U-bar 50 is a heavy, preferably solid, rigid U-shaped bar of metal or other material resistant to cutting or being broken. The U-bar 50 has an arcuate end portion 54 with a pair of parallel legs 52 extending from the arcuate end portion 54. In one of the legs 52, at least one notch 56 is formed, whereby the leg 52 may be engaged within sleeve 26a by the latch member 46. Additional notches 56 allow the locked position of the U-bar 50 to be variable, in order to accommodate different skid loader configurations or different mounting locations or arrangements of the skid steer lock 10.

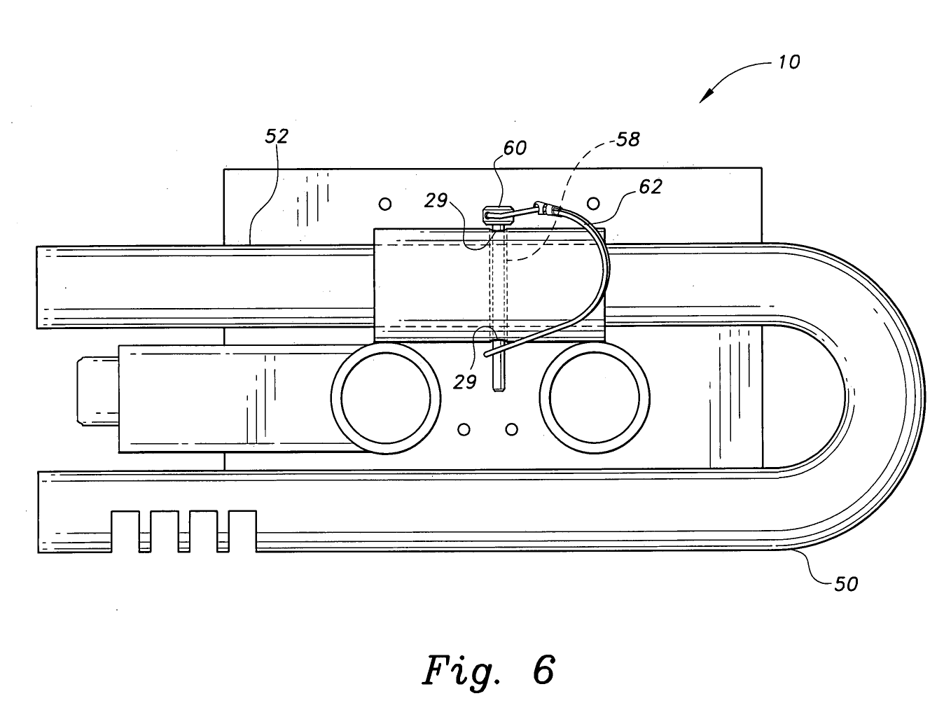

An aperture 58 may be formed transversely through one of the legs 52, to receive a pin 60 or other type of fastener to secure the leg 52 of the U-bar 50 in the storage sleeve 28, as shown in FIG. 6. When the skid steer lock 10 is not in use, the U-bar 50 may be stored by inserting one of the legs 52 into the storage sleeve 28. Apertures 29 are formed in the storage sleeve 28, in alignment with the aperture 58 in the leg 52 of the U-bar 50, through which pin 60 may be passed to secure the U-bar 50. The pin 60 includes a spring clip 62 to hold the pin 60 in place.

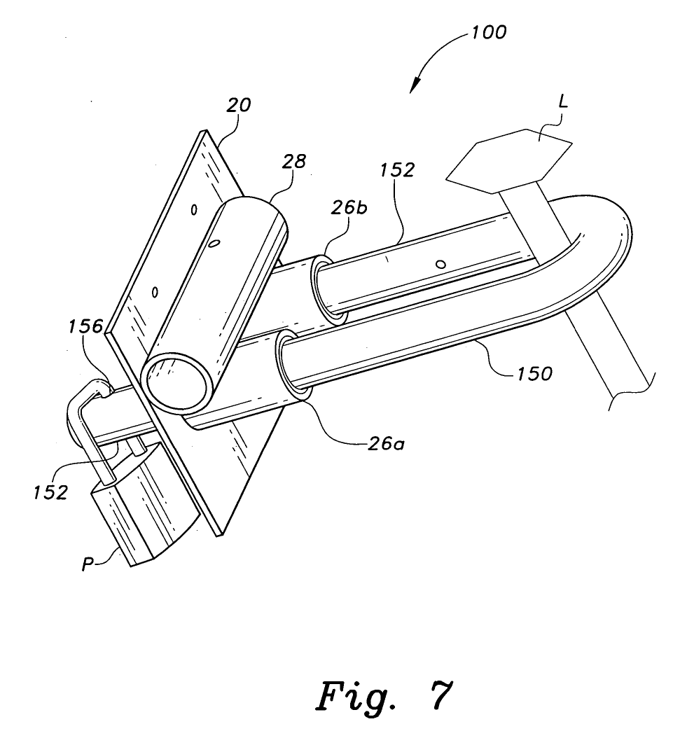

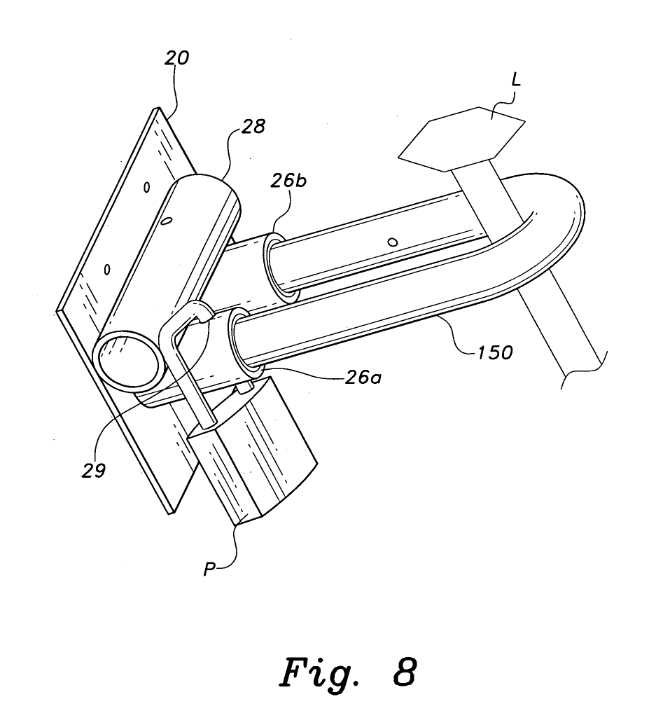

Turning now to FIGS. 7-9, another embodiment of the skid steer lock is shown, designated generally as 100 in the figures. The skid steer lock 100 is similar to the previously discussed embodiment, having a base plate 20, a pair of sleeves 26a, 26b mounted on a face of the base plate 20, and a storage sleeve 28 mounted transversely on the face of base plate 20. Unlike the previous embodiment, however, there is no locking mechanism attached to the base plate 20 or to either sleeve 26a, 26b. Instead, a separate padlock P is used to lock U-bar 50 in place, the U-bar 150 being adapted to receive the shackle of padlock P. The U-bar 150 has an aperture 156 defined near the end of one of its legs 152 to accommodate the shackle of the padlock P. FIGS. 7 and 8 show alternate arrangements for placing the padlock P. In FIG. 7, the padlock shackle is inserted through aperture 156 behind the base plate 20. In FIG. 8, the padlock shackle is inserted through apertures 29 in one of the sleeves 26a and through aperture 156 in the U-bar.

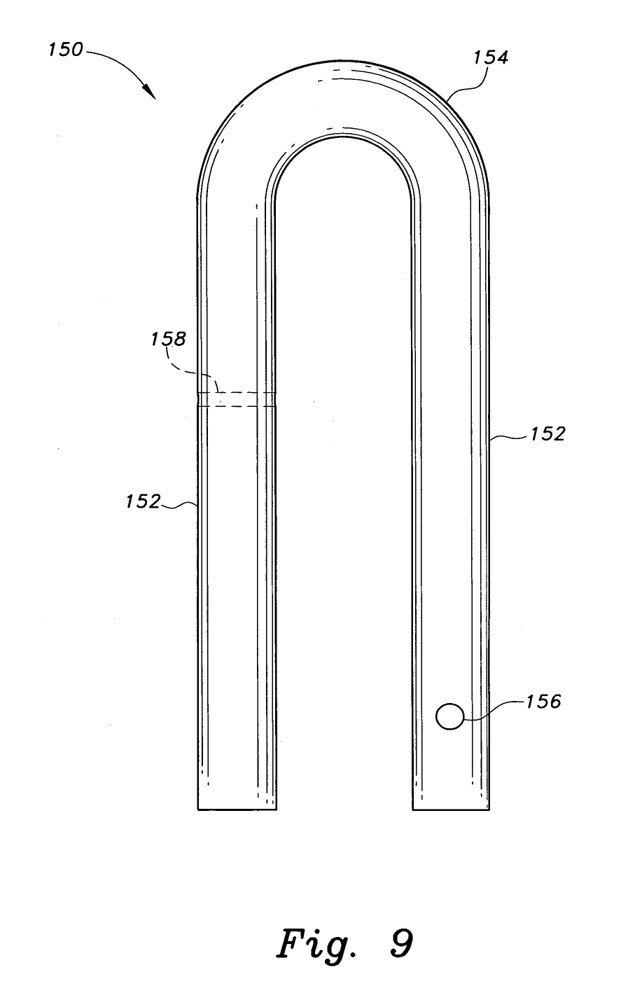

As shown in FIG. 9, an aperture 158 may be formed transversely through one of the legs 152 of the U-bar 150, to receive a pin or other type of fastener to secure the leg 152 of the U-bar 150 in the storage sleeve 28, as previously described.

It is to be understood that the present invention is not limited to the embodiments described above, but encompasses any and all embodiments within the scope of the following claims.

I claim:

1. A skidsteer lock, comprising:
a base plate having a front surface, the base plate being adapted for attachment to the skidsteer;
first and second sleeves extending normal to the front surface of the base plate;
a storage sleeve disposed on the front surface of said base plate;
a locking assembly disposed on said first sleeve, the locking assembly having a locked configuration and an unlocked configuration; and
a U-bar having an arcuate portion and first and second parallel legs extending from the arcuate portion, the legs being removably inserted in said first and second sleeves, the legs being adapted for receiving a control lever of the skidsteer there between, the U-bar being retained by said locking mechanism when the legs are inserted in said first and second sleeves and said locking assembly is in the locked configuration.

2. The skidsteer lock according to claim 1, wherein said locking assembly comprises a housing disposed on said first sleeve and a lock mechanism disposed within the housing, the lock mechanism being movable between a locked position and an unlocked position.

3. The skidsteer lock according to claim 2, wherein said lock mechanism is a combination lock mechanism.

4. The skidsteer lock according to claim 3, wherein said combination lock mechanism has a changeable combination.

5. The skidsteer lock according to claim 1, wherein said locking assembly further comprises a latch member extendible into said first sleeve when said locking assembly is in the locked configuration.

6. The skidsteer lock according to claim 5, wherein at least one notch is formed in the first leg of said U-bar, whereby said latch member engages with the slot when the legs are inserted in said first and second sleeves and said locking assembly is in the locked configuration.

7. The skidsteer lock according to claim .1, further comprising means for removably securing one of the legs of said U-bar in said storage sleeve.

8. The skidsteer lock according to claim 1, further comprising means for attaching said base plate to the safety cage of the skidsteer.

9. A skidsteer lock, comprising:
a base plate having a front surface, the base plate being adapted for attachment to the skidsteer;
first and second sleeves extending normal to the front surface of the base plate;
a storage sleeve disposed on the front surface of said base plate;
a U-bar having an arcuate portion and first and second parallel legs extending from the arcuate portion, the legs being removably inserted through the first and second sleeves, the first and second legs being adapted for receiving a control lever of the skidsteer there between; and
means for locking said first and second legs within said first and second sleeves in order to restrict movement of the control lever.

10. The skidsteer lock according to claim 9, further comprising means for removably securing one of the legs of said U-bar in said storage sleeve.

11. The skidsteer lock according to claim 9, further comprising means for attaching said base plate to a safety cage of the skidsteer.

12. The skidsteer lock according to claim 9, wherein each of the U-bar legs has a distal end passing through said base plate when the legs are inserted through the sleeves, said means for locking comprising a lock mechanism removably attached to the distal end of at least one of the U-bar legs.
